(19) United States
(12) Patent Application Publication
(10) Pub. No.: US 2003/0023532 A1
(43) Pub. Date: Jan. 30, 2003

(54) Method and system of determining the values supported by investment dollars

(76) Inventor: Stephen R. Bolt, Brent Wood, TN (US)

Correspondence Address: Myers & Associates, Intellectual Property Law, P.C., Building 3, Suite 200, 1827 Powers Ferry Road, Atlanta, GA, 30339, US

(21) Appl. No.: 09/918,419

(22) Filed: Jul. 30, 2001

(51) Int. Cl. G06F 17/60

(52) U.S. Cl. 705/36

(57) ABSTRACT

This invention provides a method and system for an investor to select from a set of values and compare to values selected to those engaged in by investments in an investment fund. This invention also allows the user to select a value and utilize search engine to find funds that satisfy those values.

### FIELD OF INVENTION

The present invention relates to a method and system for determining the values that are being supported by an investor's investment dollars through a global computer network. This permits an investor to determine whether a fund in which he or she has invested in or plans to invest owns a company that is engaged in activities, such as selling tobacco, of which the investor disapproves.

### BACKGROUND OF THE INVENTION

Many people may not want the companies in which they've invested in to engage in certain activities, such as producing or selling tobacco. If an investor owns stock in an individual company, it is fairly easy to determine whether that company engages in any activity of which the investor disapproves by examining the annual report or prospectus of the company. If the investor finds that a company in which he or she is interested in investing engages in any activity of which the investor disapproves, the investor can refrain from buying stock in that company. If an investor owns stock in a company and discovers that that company engages in an activity of which the investor disapproves, the investor can sell the stock of that company. Investors who avoid owning stock in such companies or who sell stock in any such company are attempting to avoid supporting activities of which they disapprove.

Financial theory teaches that investors should only be motivated by profits, however, many investors have a value system that requires them to disinvest stock in companies that engage in activities of which they disapprove. In these investors, views, disinvesting in such stock may relieve the conscience of the investor who does not want to invest in companies that engage in activities that the investor believes are harmful or detrimental to society. Some investors believe that by disinvesting in such companies the companies are discouraged from engaging in such activities. This discouragement is premised upon the idea that if enough investors so disinvest, the price of the stock will decline which the company does not want to see happen. The thought of this will discourage companies from investing in disfavored activities.

Many investors do not own stocks in companies directly but rather own shares in a mutual fund which in turn buys stock in various companies. By not investing in mutual funds or by disinvesting in such funds, but own stock in companies that engage in certain activities, the price of the fund may be decreased. The premise of this investment philosophy is that it will discourage funds from investing in companies that engage in disfavored activities. This in turn will decrease the price of such companies which will discourage them from engaging in certain activities.

Because a mutual fund may own stock in a number of companies, it may not be easy for an investor to determine whether the mutual fund owns stock in any company which engages in activities of which the investor disapproves. While the investor can examine the annual report or prospectus of the mutual fund and determine the stock holdings of the fund, it is not always easy to determine whether any of these companies is engaging in any activity of which the investor disapproves. In some cases it is easy for the investor to make that determination, as in the case of a fund that owns stock in a large tobacco company. However, a company may be engaged in many activities that only a small part of its business being connected with the activities in which the investor disapproves. Under those circumstances, it may not be readily apparent from examining the company's holdings of the mutual fund to determine if the fund owns stock in any company that engages in activities of which the investor disapproves. Some companies that engage in activities that it knows certain investors disapprove of take pains to avoid publicizing those activities. Consequently, it may not be easy for an investor to determine whether that company is engaged in such activities of which the investor disapproves.

It is not only mutual funds that own stock in companies, but there are also variable life and variable annuity policies which may have a stock holding underpinings. It would be desirable to have a method and a system for investors to easily determine whether a mutual fund, variable annuity or variable life policy is investing or based on stock of companies engaged in activities of which the investor disapproves. The investor would like to be able to determine this information easily and quickly.

### SUMMARY OF THIS INVENTION

It is an object of this invention to provide a system and a method whereby an investor can easily determine whether a mutual fund, variable annuity or life annuity has invested in stocks in companies engaging in activities of which the investor disapproves. It is an object of this invention to provide this information easily and quickly and to keep the information updated as the fund changes investments.

It is a further object of this invention to be able to provide the investor with a percentage of fund's investment portfolio that engages in the activities of which the investor disapproves. This is important because the percentage could be so de mininis as to be of no consequence to the investor. It may be difficult in some situations for an investor to only own funds that are 100% “pure” in that they do not engage at all in any activities of which the investor disapproves. They are currently ten to fifteen types of activities of which a significant number of investors disapprove. If those activities could be ferreted out of the information about a company and formulated into a database, an investor would be able to determine whether a fund owns stock in companies that engage in activities of which the investor disapproves.

The objects of this invention are obtained by establishing a computer database that includes a large number of mutual funds and variable life and variable annuity plans. The stockholdings of the funds and plans are analyzed and research conducted on the individual companies whose stock is owned to determine whether they engage in any specified activities of which significant number of investors may disapprove. Research is conducted to determine the types of activities of which a significant number of investors disapprove. Research is conducted on the activities of individual companies to determine whether they engage in any of these listed activities and the extent of their involvement. The company list can be compared with the holdings of the fund and the extent of the fund's involvement and the extent of the fund's investment in companies engaged in such activities determined.

A computer program is provided that allows the investor to select a fund or funds to be searched and extract from the database the extent involvement of the fund in activities of which the investor disapproves. The program permits the investor to select from a list of activities of which he or she disapproves for screening a fund.

This method and system is designed so that any prospective investor of a fund, or a plan or any actual investor can determine the extent of the disfavored activities of companies whose stock is owned by the fund or plan. This method and system allows prospective investors to browse through a list of funds or plans that he or she may be interested in purchasing to determine the extent of their holdings with activities of which the investor disapproves. In this way the investor can avoid funds that have holdings involved in activities of which the investor disapproves.

### BRIEF DESCRIPTION OF THE DRAWINGS

Other objects and advantages of the present invention will become more apparent from the following description of the preferred embodiments in reference to the drawings.

FIG. 1 is a flow chart which shows the program of this invention as viewed by the user.

FIG. 2 is a flow chart showing a program of this invention for integrating the values of the potential investor and displaying funds from a database that reflect the potential investor's values.

### DETAILED DESCRIPTION OF THE PREFERRED EMBODIMENT

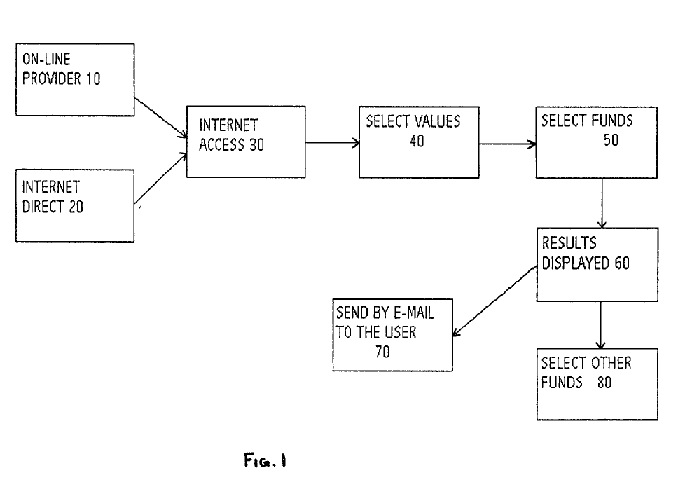

The program according to the present invention will be described by reference to FIG. 1 as a flow chart showing the access to program and the selection choices available to the user. In FIG. 1, the numeral 10 indicates access via an on-line provider such as AOL™, CompuServe™, the numeral 20 indicates a direct access to the global computer network such as via Netscape™. After gaining access to the Internet 30 the program proceeds to a first selection menu to select values 40. The user can be provided with a list of ten or so values from which to select. Common values that many investors are concerned with are “tobacco, same sex lifestyle, pornography, nuclear power, gambling, foreign environmental record, defense contracting, alcohol, affirmative action and abortion. These values are not meant to be an exclusive list and it will be appreciated that the values may change from time to time. The potential investor can check one or more values on the list that is of concern to him or her. In order to conduct a meaningful screening based on the values, the values need to be defined. For example, a foreign environmental record could be based upon toxic emissions, oil and chemical spills and/or fines. It will be appreciated that the criteria for these values needs to well defined. For example, the alcohol value may be violated by a company that produces and distributes alcohol or by a company that owns bars, but not by a company that owns restaurants in which alcohol is sold. The necessary refinement of the values does not affect the general operation of this program.

The user then proceeds to select the funds 50 which he or she wishes to have evaluated. Domestic equity mutual funds, variable annuity sub-accounts and variable life sub-accounts can be evaluated. Various 401K plans can also be evaluated. The developer of this program can decide which funds and accounts to include in the screening process. The user can select the funds by typing in the name of the fund family. A list of various funds within that family can be supplied from which the investor may select. This selection process can be made user friendly by permitting the user to type in the first few letters of the fund which will then be displayed. The user may be able to select a number of funds at this time. The computer program will arrange for the necessary searching of the funds in relation to the values and display the results 60. These results can be sent by email to the user 70 so that he or she has a hard copy of the results.

This process can be continued by selecting other funds 80 to be evaluated by the same values or by returning to the same select values 40 menu and searching for other values.

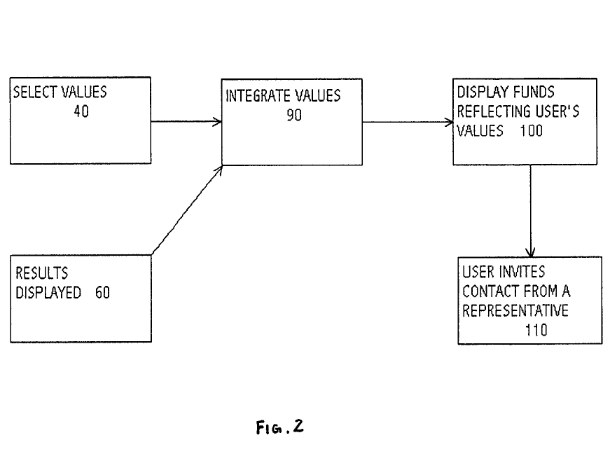

The process illustrated in FIG. 1 is a complete process and the user can take the results obtained and act accordingly. However this may not leave the user with many or any investment options as there may be issues concerning the funds displayed that would deter the investor from purchasing such funds or retaining an investment in such funds. Ideally, the perspective investor would like to have available a number of funds in which to invest that accurately reflect his or her values. As illustrated in FIG. 2 the program of this invention can aid the investor in finding funds that reflect his or her values. The first step in this process is to integrate the values 90 as shown in FIG. 2. This can be done after completing the steps in FIG. 1 or accessed directly after selecting the values 40 in FIG. 1. In integrating the values, the investor or the user must identify the values that he or she has a chosen as an issue. Values are integrated by excluding companies from the user's portfolio that engage in activities of which the user disapproves. The user can exclude these companies “from my portfolio” box on the computer screen. On the other hand the user may want to take a more active role and include companies that espouse certain values. For example if the user wants to encourage affirmative action and wanted to support those companies who promote workplace diversity, he or she can click “include these companies in my portfolio” box on the computer screen. Once the values have been integrated, the program will select from its database funds that reflect the user's values 100. This program is not designed to sell investment or insurance products, but simply provide information. The sale of investment insurance products can only be made through individuals and firms that are licensed to do so. Rather the program of this invention simply displays funds and plans that match the user's values.

As illustrated in FIG. 2, the user is given opportunity to invite contact from a representative 110 to discuss his or her values and investment possibilities. This contact can be invited by the user supplying information about himself or herself, such as address and investment information, (ie. income, age and financial objectives).

In the description of the preferred embodiment, the term “user” is used is primarily to refer to investors and potential investors but the program can be made accessible to others as well.

The network interface with the user can be by conventional, internal, or external modems. The preferred embodiment, the network interface, is connected with the Internet and/or any of the commercial on-line services, such as AOL™, CompuServe™ or Prodigy™.

While the above embodiment describes a single computer acting as a central controller, those skilled in the art will realize that the functionality can be distributed over a plurality of computers. In one embodiment, the central controller is configured in a distributed architecture, wherein the databases and processors are housed in separated units or locations. Those skilled in the art will appreciate that an almost unlimited number of controllers may be supported. This arrangement yields a more dynamic and flexible system, less prone to catastrophe or hardware failure affecting the entire system.

In the preferred embodiment, the user can utilize a conventional personal computer having an in-put device, such as a keyboard, mouse or conventional voice recognition software package; a display device, such as a video monitor, a processing device, such as a CPU, and a network interface such as a modem. These devices interface with a central controller.

Any conventional search engine may be used in selecting investment funds to satisfy the users' selected values. Any conventional search engine may be used for this purpose. A search engine can be implemented by collecting the users' response to the set of values presented.

While the invention has been disclosed in its preferred forms, it will be apparent to those skilled in the art that may modification, additions and deletions can be made therein without departing from the spirit and scope of the invention and its equivalents as set forth in the following claims.

### UNIQUE FEATURES OF THIS METHOD AND SYSTEM

One of the unique features of method and system of this invention is provision of means whereby a user can compare his or her values selected from a list of values with the activities of investments owned by particular investment fund. It also permits the potential investor to select a value and use a search engine to search investment funds that meet the values selected.

What is claimed is:

1. A method for comparing investments selected by a user with values also selected by the user, through a computer accessible for on-line interactive communication with users, comprising the steps of:
a. maintaining a list of values with the capability of the user selecting a value from the list;
b. maintaining a database of the investments of investment funds with information on each investment as to the list of values; and
c. providing an interactive on-line access to users to select a value and screen selected investment funds in respect to the value selected.

2. The method claim 2 of providing users with the capability of selecting values and providing search engine capability to design a search of funds to fit the user's selected value.

3. A computer readable substrate having a computer program saved thereon, said computer program comprising the steps of:
a. providing a user with on-line access to a list of values homepage and a list of funds homepage;
b. providing said user with the capability of selecting a value from the list of values; and
c. providing said user with the capabilities of selecting a fund and screening that fund for the value selected by the user.

4. A system for the supply of information concerning whether any investment of a selected investment fund is involved in any activities related to a value selected by the user from a list of values comprising:
a. a first memory area for storing a list of values; and
b. a second memory area for storing information on the list of values for a list of investment funds.

5. The system of claim 4, wherein said computer system is programmed to perform steps comprising:
a. providing a user with on-line access to the list of value homepage and the list of investment funds homepage, said first memory area, said list of values homepage linking to said first memory area, said list of investment funds homepage linking to said second memory area;
b. providing on-line capabilities of viewing each of the homepages and selecting a value and investment fund; and
c. providing on-line capability of screening each investment fund selected in relation to the value selected and providing the user with the capability of viewing the results.

6. The system of claim 5 of providing the user with search engine capability to design a search of investment funds that meet the user's values.
